(19) United States
(12) Patent Application Publication
(10) Pub. No.: US 2025/0183988 A1
(43) Pub. Date: Jun. 5, 2025

(54) USER EQUIPMENT RECEPTION BEAM REFINEMENT BASED ON MEASUREMENT OF SECOND USER EQUIPMENT

(71) Applicant: Nokia Technologies Oy, Espoo (FI)

(72) Inventors: Ali KARIMIDEHKORDI, Munich (DE); Samantha CAPORAL DEL BARRIO, Aalborg (DK); Alessio MARCONE, Munich (DE); Benny VEJLGAARD, Aalborg (DK)

(21) Appl. No.: 18/837,775

(22) PCT Filed: Feb. 13, 2023
(86) PCT No.: PCT/FI2023/050087

§ 371 Date: Aug. 12, 2024

Related U.S. Application Data
(60) Provisional application No. 63/311,250, filed on Feb. 17, 2022.

(51) Int. Cl. H04B 7/08; H04W 72/11; H04W 72/23

(52) U.S. Cl. CPC H04B 7/088; H04W 72/11; H04W 72/23

(57) ABSTRACT

Systems, methods, apparatuses, and computer program products for facilitation of beam refinement for a user equipment are provided. For example, a method can include receiving, at a user equipment, a downlink configuration for a beam selection procedure. The method can also include receiving, at the user equipment, an indication to use a signal in the beam selection procedure. The signal can be targeted at another user equipment. The user equipment and the another user equipment can be served by a same beam or by similar beams. The method can further include receiving the signal by the user equipment. The signal can be transmitted on a beam corresponding to the same beam or one of the similar beams. The method can additionally include performing, by the user equipment, the beam selection procedure based on measurements of the signal.

### CROSS REFERENCE TO RELATED APPLICATION

This application claims the benefit of U.S. Provisional Application No. 63/311,250, filed Feb. 17, 2022, the entire contents of which is hereby incorporated by reference.

### FIELD

Some example embodiments may generally relate to communications including mobile or wireless telecommunication systems, such as Long Term Evolution (LTE) or fifth generation (5G) radio access technology or new radio (NR) access technology, or other communications systems. For example, certain example embodiments may generally relate to systems and/or methods for providing facilitation of beam refinement for a user equipment.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. 5G wireless systems refer to the next generation (NG) of radio systems and network architecture. A 5G system is mostly built on a 5G new radio (NR), but a 5G (or NG) network can also build on the E-UTRA radio. It is estimated that NR provides bitrates on the order of 10-20 Gbit/s or higher, and can support at least service categories such as enhanced mobile broadband (eMBB) and ultra-reliable low-latency-communication (URLLC) as well as massive machine type communication (mMTC). NR is expected to deliver extreme broadband and ultra-robust, low latency connectivity and massive networking to support the Internet of Things (IoT). With IoT and machine-to-machine (M2M) communication becoming more widespread, there will be a growing need for networks that meet the needs of lower power, low data rate, and long battery life. The next generation radio access network (NG-RAN) represents the RAN for 5G, which can provide both NR and LTE (and LTE-Advanced) radio accesses. It is noted that, in 5G, the nodes that can provide radio access functionality to a user equipment (i.e., similar to the Node B, NB, in UTRAN or the evolved NB, eNB, in LTE) may be named next-generation NB (gNB) when built on NR radio and may be named next-generation eNB (NG-eNB) when built on E-UTRA radio.

### SUMMARY

An embodiment may be directed to an apparatus. The apparatus can include at least one processor and at least one memory comprising computer program code. The at least one memory and computer program code can be configured, with the at least one processor, to cause the apparatus at least to perform receiving a downlink configuration for a beam selection procedure. The at least one memory and computer program code can also be configured, with the at least one processor, to cause the apparatus at least to perform receiving an indication to use a signal in the beam selection procedure. The signal can be targeted at a user equipment other than the apparatus. The apparatus and the user equipment can be served by a same beam or by similar beams. The at least one memory and computer program code can further be configured, with the at least one processor, to cause the apparatus at least to perform receiving the signal. The signal can be transmitted on a beam corresponding to the same beam or one of the similar beams. The at least one memory and computer program code can additionally be configured, with the at least one processor, to cause the apparatus at least to perform the beam selection procedure based on measurements of the signal.

An embodiment may be directed to an apparatus. The apparatus can include at least one processor and at least one memory comprising computer program code. The at least one memory and computer program code can be configured, with the at least one processor, to cause the apparatus at least to perform determining a user equipment to perform a beam selection procedure. The beam selection procedure can be a procedure to be performed using a signal targeted at another user equipment. The user equipment and the another user equipment can be served by a same beam or by similar beams. The at least one memory and computer program code can also be configured, with the at least one processor, to cause the apparatus at least to perform sending a downlink configuration for the beam selection procedure to the user equipment. The at least one memory and computer program code can further be configured, with the at least one processor, to cause the apparatus at least to perform sending an indication to the user equipment to use the signal to perform the beam selection procedure. The at least one memory and computer program code can additionally be configured, with the at least one processor, to cause the apparatus at least to perform sending the signal using a beam corresponds to the same beam or one of the similar beams.

An embodiment may be directed to a method. The method may include receiving, at a user equipment, a downlink configuration for a beam selection procedure. The method may also include receiving, at the user equipment, an indication to use a signal in the beam selection procedure. The signal can be targeted at another user equipment. The user equipment and the another user equipment can be served by a same beam or by similar beams. The method may further include receiving the signal by the user equipment. The signal can transmitted on a beam corresponding to the same beam or one of the similar beams. The method may additionally include performing, by the user equipment, the beam selection procedure based on measurements of the signal.

An embodiment may be directed to a method. The method may include determining, by a network element, a user equipment to perform a beam selection procedure. The beam selection procedure may be a procedure to be performed using a signal targeted at another user equipment. The user equipment and the another user equipment may be served by a same beam or by similar beams. The method may also include sending, by the network element, a downlink configuration for the beam selection procedure to the user equipment. The method may further include sending, by the network element, an indication to the user equipment to use the signal to perform the beam selection procedure. The method may additionally include sending, by the network element, the signal using a beam corresponds to the same beam or one of the similar beams.

An embodiment may be directed to an apparatus. The apparatus may include means for receiving a downlink configuration for a beam selection procedure. The apparatus may also include means for receiving an indication to use a signal in the beam selection procedure. The signal can be targeted at a user equipment other than the apparatus. The apparatus and the user equipment can be served by a same beam or by similar beams. The apparatus may further include means for receiving the signal. The signal can be transmitted on a beam corresponding to the same beam or one of the similar beams. The apparatus may additionally include means for performing the beam selection procedure based on measurements of the signal.

An embodiment may be directed to an apparatus. The apparatus may include means for determining a user equipment to perform a beam selection procedure. The beam selection procedure can be a procedure to be performed using a signal targeted at another user equipment. The user equipment and the another user equipment can be served by a same beam or by similar beams. The apparatus may also include means for sending a downlink configuration for the beam selection procedure to the user equipment. The apparatus may further include means for sending an indication to the user equipment to use the signal to perform the beam selection procedure. The apparatus may additionally include means for sending the signal using a beam corresponds to the same beam or one of the similar beams.

### BRIEF DESCRIPTION OF THE DRAWINGS

For proper understanding of example embodiments, reference should be made to the accompanying drawings, wherein:

FIG. 1 illustrates an information element for a resource set;

FIG. 2 illustrates an information element for a resource identifier;

FIG. 3 illustrates three stages of beam shaping, according to certain embodiments;

FIG. 4 illustrates a flowchart diagram of certain embodiments;

FIG. 5 illustrates a signaling flowchart example of certain embodiments;

FIG. 6 provides three examples of user equipment reception spatial filter configurations;

FIG. 7 illustrates a comparison of different repetition use cases with a four receive beam configuration, according to certain embodiments;

FIG. 8 presents one example of performing measurements based on data symbols, according to certain embodiments;

FIG. 9 illustrates an example flow diagram of a method, according to an embodiment;

FIG. 10 illustrates an example flow diagram of a method, according to an embodiment;

FIG. 11 illustrates an example block diagram of a system, according to an embodiment;

FIG. 12 illustrates an example flow diagram of a method, according to an embodiment;

FIG. 13 illustrates an example flow diagram of a method, according to an embodiment;

FIG. 14 illustrates a dynamic process of beam selection, according to certain embodiments;

FIG. 15 illustrates a signal flow chart according to certain embodiments;

FIG. 16 illustrates a further signal flow chart according to certain embodiments;

FIG. 17 illustrates yet another signal flow chart according to certain embodiments;

FIG. 18 illustrates an additional signal flow chart according to certain embodiments; and

FIG. 19 illustrates another signal flow chart according to certain embodiments.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for providing facilitation of beam refinement for a user equipment, is not intended to limit the scope of certain embodiments but is representative of selected example embodiments.

The features, structures, or characteristics of example embodiments described throughout this specification may be combined in any suitable manner in one or more example embodiments. For example, the usage of the phrases “certain embodiments,” “some embodiments,” or other similar language, throughout this specification refers to the fact that a particular feature, structure, or characteristic described in connection with an embodiment may be included in at least one embodiment. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more example embodiments.

Certain embodiments may have various aspects and features. These aspects and features may be applied alone or in any desired combination with one another. Other features, procedures, and elements may also be applied in combination with some or all of the aspects and features disclosed herein.

Additionally, if desired, the different functions or procedures discussed below may be performed in a different order and/or concurrently with each other. Furthermore, if desired, one or more of the described functions or procedures may be optional or may be combined. As such, the following description should be considered as illustrative of the principles and teachings of certain example embodiments, and not in limitation thereof.

Certain embodiments relate to methods, devices, and systems to facilitate beam refinement procedures. Certain embodiments may be applicable to fifth generation (5G) new radio (NR).

Multi-panel beam-based communication is one way for 5G NR to enhance network capacity, throughput, and reliability. Transmission/reception through directive narrow beams generated by high-dimensional phased arrays may increase signal quality at any desired user-equipment (UE), may reduce interference over neighboring nodes, and may compensate for additional propagation path-loss due to using higher carrier frequencies, for example, frequency in the millimeter (mm) wave bands.

A single panel UE can be a UE with a single two-dimensional array of antennas, for example, along one side of the case of the device. By contrast, a UE with multiple-panels may be, for example, a UE with antenna arrays along three different sides of the case of the device. The antenna arrays can provide spherical coverage, with the multi-panel UE potentially providing a very highly optimizable coverage.

Beam based multi-panel operation may be used to optimize the spherical coverage of a UE at mm-wave frequencies. A single panel UE may only be able to transmit/receive from a limited number of angles, but a multi-panel UE may be capable of much greater flexibility and consequently may benefit from optimization.

In order to fully capture beamforming gains, low-latency beam management techniques can be used for initial access, beam tracking, beam/radio link failure recovery, and during handover procedures. In NR, beam management can be a set of Layer 1 (also referred to as physical (PHY) layer) and Layer 2 (as referred to as medium access control (MAC) layer) procedures. The procedures may mainly rely on measurements of sounding signals, such as Synchronization Signal Block (SSB) and Channel State Information Reference Signal (CSI-RS) in downlink (DL) and Sounding Reference Signal (SRS) in UL transmission.

5G NR beam pair establishment between the gNB and UE can include three phases. For ease of reference, these three phases can be respectively referred to as phase 1 (P1), phase 2 (P2), and phase 3 (P3). As will be explained below, certain embodiments may be particularly beneficial to P3.

P1 can include gNB wide SSB-beam transmission and UE panel selection. When the idle-mode UE wants to establish a connection, the idle-mode UE may acquire frame synchronization information and perform a random access (RA) procedure. For this purpose, the gNB can broadcast a set of wide SSB beams, which can be referred to as a synchronization signal (SS) burst, in different directions. Each SS burst can carry dedicated information such as Primary Synchronization Signal (PSS), Secondary Synchronization Signal (SSS), Physical Broadcast Channel (PBCH), Demodulation Reference Signal (DMRS), and the like.

Each SS burst can be 5 msec long and can include up to 64 SSBs, in frequency range 2 (FR2). Depending on the network configurations, SS burst can have a periodicity between 5 to 160 msec, with a default being 20 msec. The UE can measure the reference signal received power (RSRP) of the beams in the SS burst from different panels, can decode cell specific information, and can select the best panel. Moreover, the UE can initiate an initial access procedure by triggering RA transmission over the best measured SSB beam (or by selecting one the SSBs above a RSRP threshold) physical Random Access Occasion (RO) and corresponding Random Access Channel (RACH) configurations.

P2 can include narrow CSI-RS beam selection. After successful initial access connection, the UE can be in radio resource control (RRC) connected mode (RRC_Connected) to the gNB through the wide SSB Beam established at P1. The network may then try to further boost the throughput by communicating over a narrower beam, which can be referred to as P2. Both P1 and P2 can be considered phases of initial access. To this end, a set of finer CSI-RS beams can be configured and transmitted within the angular range of the corresponding SSB-Beam. The UE can measure beams and can report a set of N best beams to the network. The network may select the best beam (corresponding to higher RSRP or SINR values) as the serving beam and may provide the UE with beam failure recovery (BFR) configurations over the other ones.

P3 can include device Rx beam refinement. The UE may align the UE's own narrow beam while the gNB maintains and repeats a fixed CSI-RS. P3 may be considered the third phase of initial access. In P3, the UE may rely on the reference signals associated with NZP-CSI-RS-ResourceSet configured with the higher layer parameter repetition set to ‘ON’ from the gNB in order to perform the UE's own narrow beam alignment procedure. The repetition parameter can indicate to the UE that the NZP-CSI-RS-ResourceSet are transmitted with the same downlink spatial filter, as described at 3GPP technical specification (TS) 38.214, section 5.1.6.1.2. The scheduling of such reference signals may be fully controlled by the gNB and such reference signals may be sent in an aperiodic fashion. Hence, the UE may be limited to waiting for the gNB to schedule such reference signals in order for the UE to align the UE's own Rx beam.

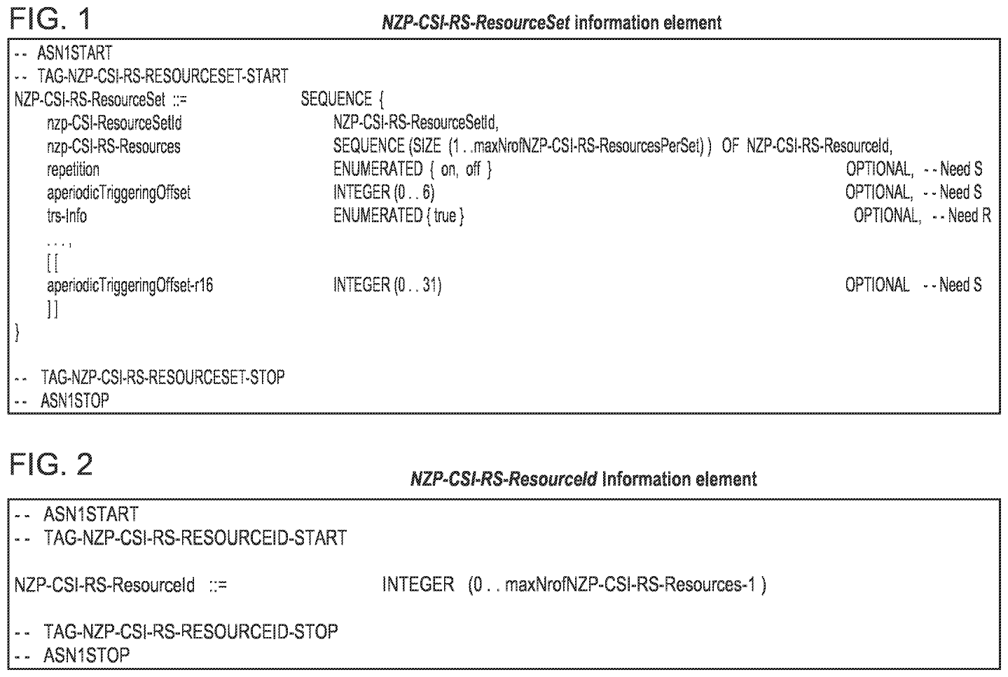

The serving cell can indicate to the UE the index of CSI-RS resource set whose transmission will be repeated. FIG. 1 illustrates an information element for a resource set. Specifically, the information element in FIG. 1 identifies nzp-CSI-RS-Resources. In this case, the “repetition” information element (IE) of nzp-CSI-RS-ResourceSet can be set to “on”. FIG. 2 illustrates an information element for a resource identifier.

Release 15 (Rel-15) defines a static UE capability maxNumberRxBeam, where the UE can indicate a single value for the preferred number of NZP CSI-RS resource repetitions (number of CSI-RS resources) per CSI-RS resource set. This value can be for the entire UE across all panels, not a dynamic value depending on active panel and/or supporting channel.

UEs may be built with at least three panels, each of them being 1×4 (or 1×8) antenna arrays extending along an edge of the UE's case and exhibiting several different beam configurations. For example, a UE may exhibit 8 different beam configurations per panel, or even more including hierarchical configurations. However, the number of gNB allocated CSI-RS repetitions may be much smaller than the total UE beam configurations, since a high number of repetitions is resource consuming, which may be an issue in loaded cell scenarios. Indeed, the UE may have, for example 24 narrow beams, to test for narrow beam alignment to achieve maximum gain. However, providing resources from the gNB for 24 CSI-RS repetitions (e.g. 24 symbols) is a large allocation of resources dedicated to beam management of a single UE and not to UL/DL data communication. Such allocation may need to be given with a high periodicity (for example, in mobility scenarios) and to each UE in the cell. High load on the gNB cell can vastly increase the number of CSI-RS repetition resources needed. The high periodicity and high load can reduce the resources that may be allocated to UL/DL data communication (for example, PDSCH and PUSCH), and hence may reduce achievable cell throughput. Therefore, it may be beneficial to reduce the amount of resources needed for CSI-RS repetition. This is the goal of this invention where resources for narrow beam alignment may be shared among UEs in the same CSI beam.

The gNB can be in control of the repetition parameters used for the UE to align the UE's own narrow beam at P3. It is possible that the gNB may configure the NZP-CSI-RS-ResourceSet in a suboptimal manner where the UE may only get a few assigned resources to optimize cell resources. Moreover, due to user mobility and rotation, the need for realignment of UE receive beam may become more frequent, and may significantly increase resource usage of performing CSI-RS repetition.

It is possible that two UEs may be served from the same beam in P3. Certain embodiments may reduce the number of CSI-RS beam repetitions and maintain UE refined beams for optimized performance. For example, certain embodiments may maintain link throughput and/or reliability.

Certain embodiments enhance the UE Rx beam selection procedure by performing UE beam search phase P3 over the physical DL shared channel (PDSCH) resources (for example DMRS and/or data symbols) that are transmitted to secondary users. This approach may be particularly beneficial if the secondary UEs are being served from the same gNB beam as that of the UE.

With certain embodiments, the UE could fine-tune the UE's receive beam more frequently and without the need for transmission of UE dedicated CSI-RS repetitions. As such, the network may be able to reuse PDSCH for simultaneous beam refinement of other UEs, which may significantly reduce network resource consumption.

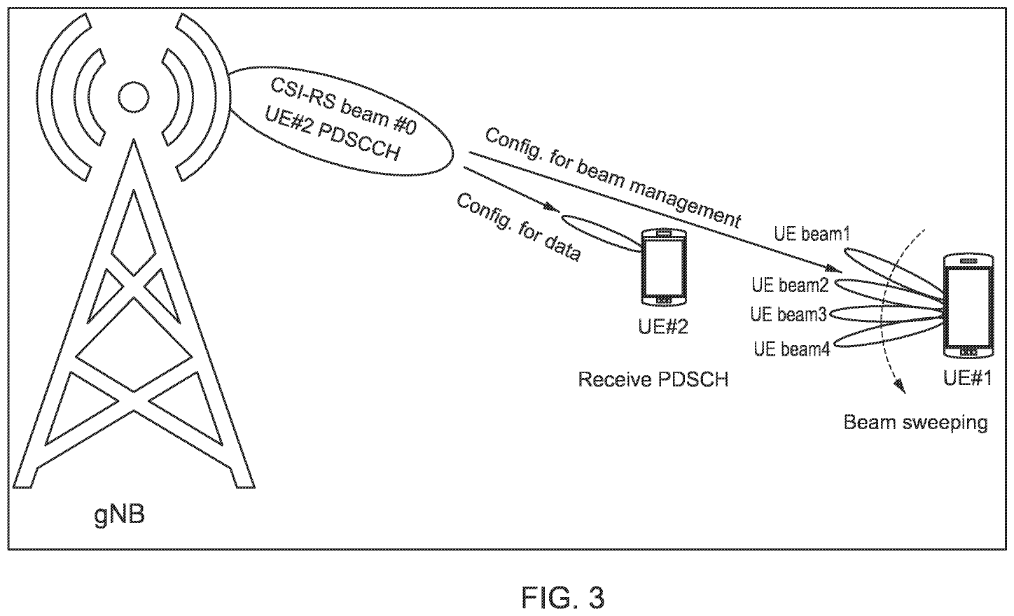

FIG. 3 illustrates three stages of beam shaping, according to certain embodiments. In the example of FIG. 3, UE #1 could align its narrow beam based on the PDSCH transmissions for UE #2, when both UE #1 and UE #2 are in the same CSI beam. For example, both UE #1 and UE #2 may share a same DL Tx spatial filter from gNB. Without certain embodiments, the network needs to assign repetitions dedicated to UE #1 and other repetitions dedicated to UE #2. In certain embodiments, UE #1 can align UE #1's beam based on PDSCH transmission to UE #2 and/or vice versa. This may dramatically reduce the need for repetitions. The network can make a decision on which UEs act as UE #1 or UE #2. The gNB can indicate the roles of the UEs. The gNB may be the network element that has the information on which UEs are served by which gNB CSI beam. This way, the gNB can identify UE pairs that are covered by the same gNB CSI beam and capable of operating as UE #1 and UE #2 in FIG. 3.

Certain embodiments may configure the UE (UE #1 in FIG. 3) with a secondary PDSCH that can only be used for beam management, in order for the gNB to share resources, and thereby optimize resource usage. Indeed, two UEs sharing the same gNB CSI beam may use PDSCH scheduling of the one UE for refined beam alignment of the other UE, thus reducing or even avoiding the need for CSI-RS repetitions. For example, both UEs may have the same DL Tx spatial filter from gNB.

In the example of FIG. 3, both UE #1 and UE #2 may report CSI-RS beam #0 as the serving beam. The gNB can share UE #2's PDSCH configurations to UE #1. UE #1 can use DMRS or data symbols of UE #2 PDSCH and can perform P3 instead of waiting for CSI-RS repetitions dedicated to UE #1. In this way, the network may be able in some cases to entirely avoid the need for CSI-RS repetitions for UE #1.

FIG. 3 illustrates one scenario in which two users, in this case UE #1 and UE #2, can be served from the same gNB beam, in this case CSI-RS #0. The network can serve UE #2 with semi-persistent scheduling (SPS) scheme, each with length of M consecutive slots and periodicity of TO. The main novel aspect is gNB also provides UE #1 with PDSCH configurations of UE #2, so UE #1 knows main configuration properties of DMRS and data positions which enables it to perform UE beam sweeping and select the optimum receive beam (P3) by measuring the received signal power of DMRS (or data) symbols.

In this scenario, the UE (for example UE #1) can perform Rx beam sweeping (i.e. P3) by measuring the RSRP of PDSCH RS or data transmitted to a secondary UE (in this example UE #2). In this case, the gNB does not need to transmit dedicated CSI-RS repetitions to UE #1 for P3. This lack of need to transmit dedicated CSI-RS repetitions can save resources.

In an additional embodiment, UE #1 and UE #2 may also belong to different gNB CSI beams as long as they are received with best DL on the same UE narrow beam.

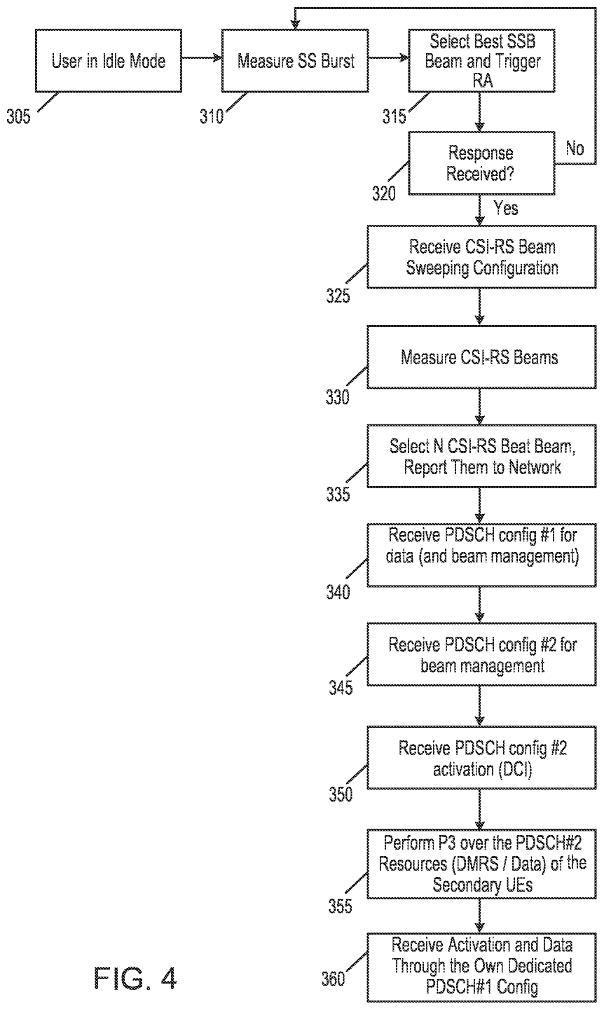

FIG. 4 illustrates a flowchart diagram of certain embodiments. At 305, the user equipment may be in idle mode. At 310 an SS burst can be measured. At 315, a best SSB beam can be selected and RA can be triggered. If no response is received at 320, SS burst can be measured again, and so on. When a response is received at 320, the UE can receive a CSI-RS beam sweeping configuration.

At 330, the UE can estimate the channel environment using RSRP values across sweeping sets of the reference signals, for example SS burst or CSI-RS beam sweeping. At 335, the UE can can select and report a set of N beams including a serving beam (usually a beam with the highest measured RSRP or SINR value) and N−1 backup beams mainly for beam-failure recovery.

The gNB can make a decision on the serving beam and, based on the network traffic, can configure the UE with two sets of PDSCH configurations, a first configuration at 340 and a second configuration at 345 and 350. The first set can be the UE-specific PDSCH configurations that are used by this UE for data reception in DL. The second set can be the PDSCH configuration, which may be intended only to enable Rx beam refinement (as shown at 345) at the UE and not for actual data transmission to the UE, as the second set can be the PDSCH configuration of data for another UE served by the same gNB beam. This second set can include PDSCH related configurations such as periodicity, allocated resources, DMRS type/positions, without including information compromising user security.

In certain embodiments, such configuration can contain parameters of a specific ongoing SPS transmission on the serving beam.

In another embodiment, such configuration could contain parameters of a shared PDSCH configuration. The shared PDSCH configuration can be a specific PDSCH configuration that the gNB expects to be used in most cases and, which may be suitable for serving most of UEs.

As shown at 350, the PDSCH configuration #2 can be activated with downlink control information (DCI). For example, when a DL transmission according to the second set of PDSCH configurations occurs, the gNB can inform the UE about the DL transmission so it can perform P3 at 355.

In case of dynamic scheduling (shared PDSCH configuration), as shown at 350 the gNB sends DCI in CommonSearchSpace including transmission details (time offset of DL transmission from reception of DCI, time-frequency resources, etc.) that can be used for P3 at 355, also indicating the UE that it does not need to decode data. The shared configuration can omit RNTI information and therefore the UE may be incapable of decoding the data, thereby preserving security.

In case of SPS, the gNB can inform the UE with one PDCCH indicating the activation of the SPS transmission.

Once receiving the secondary PDSCH configuration intended for P3 and when transmission occurs, the UE can perform P3 over the scheduled resources at 355.

In one embodiment, the UE performs P3 using embedded DMRS symbols.

In another embodiment and in case of limited interference environment, which can be evaluated by decoding DMRS symbols, the UE could also or alternatively select the Rx beam by performing energy measurement of data symbols.

As shown at 360, the UE can receive activation and data through the UE's own dedicated PDSCH #1 configuration.

Certain embodiments may have various features and characteristics. For example, in certain embodiments, the network can provide the UE with two sets of PDSCH configurations. The network can decide which UEs to configure with two sets of PDSCH configurations based on CSI reporting from the UEs. The first set (for example, PDSCH config. #1 in FIG. 4) can be used for actual data transmission.

The second set (for example, PDSCH config. #2 in FIG. 4) originally belonging to other subscribers can be shared to the UE, so that the UE can extract the DMRS and data configuration and use such information to refine the UE's own Rx beam.

The UE can selects the UE's receive P3 beam by performing Rx beam sweeping over the DMRS (and/or data) resources shared by the second set of PDSCH config, config #2. Then the UE can receive the actual data using the first PDSCH config #1 (as shown at 360 in FIG. 4).

In an additional embodiment, the UE can determine not only the best gNB CSI beam for the UE's own data reception, but also the gNB CSI beams that can be used to perform P3 interchangeably.

The UE can identify gNB beams that are received through the similar path, for example those gNB beams that can be used for P3 refinement. As discussed below, the similar path can be the same or a similar reception beam. A beam can be considered similar to another beam if the two beams are directional beams with overlap or if the two beams are adjacent beams.

The UE can provide the network with information of the beams that are received from similar path as that of serving beam.

A similar beam can refer to a gNB beam that would be best received by the UE with the same UE Rx spatial filter as for the original beam. For example, if the UE aligns on CSI #1, the UE can try all of the UE's beams in P3 and conclude that UE beam #2 is the best one. In this example, a similar beam may be CSI #2 where if the UE aligns on CSI #2, the UE's best beam would still be UE beam #2.

The UE can select the UE's best narrow beam for a serving gNB beam by comparing all reference signal received power (RSRP)/signal to interference and noise ratio (SINR) values received during P3, for example DL reception of a serving gNB beam received with multiple UE beams.

The UE beam receiving the serving gNB beam with the highest power can be considered the best UE beam. The UE can select this beam to receive serving gNB beam.

A similar beam can refer to another gNB beam that would lead the UE to select the same UE narrow beam (for example, because it is received with highest power) as for the serving beam. Thus, in certain embodiments, the gNB may select a similar beam to configure the UE for beam alignment.

The gNB can use the information provided by the UE on the best gNB CSI beam and on the gNB CSI beams that can be used to perform P3 interchangeably to configure UE pairs (for example, UE #1 and UE #2 in FIG. 3).

Certain embodiments can save resources by reducing the number of CSI-RS beam repetition transmissions at the network. Certain embodiments may also improve the UE reception/transmission performance by enabling the UE to tune the UE's own receive beam more frequently without the need to trigger CSI-RS repetition request. Certain embodiments can also be used for beam switching and during handover procedure so that the UE can faster tune the UE's own receive beam with the new gNB serving beam.

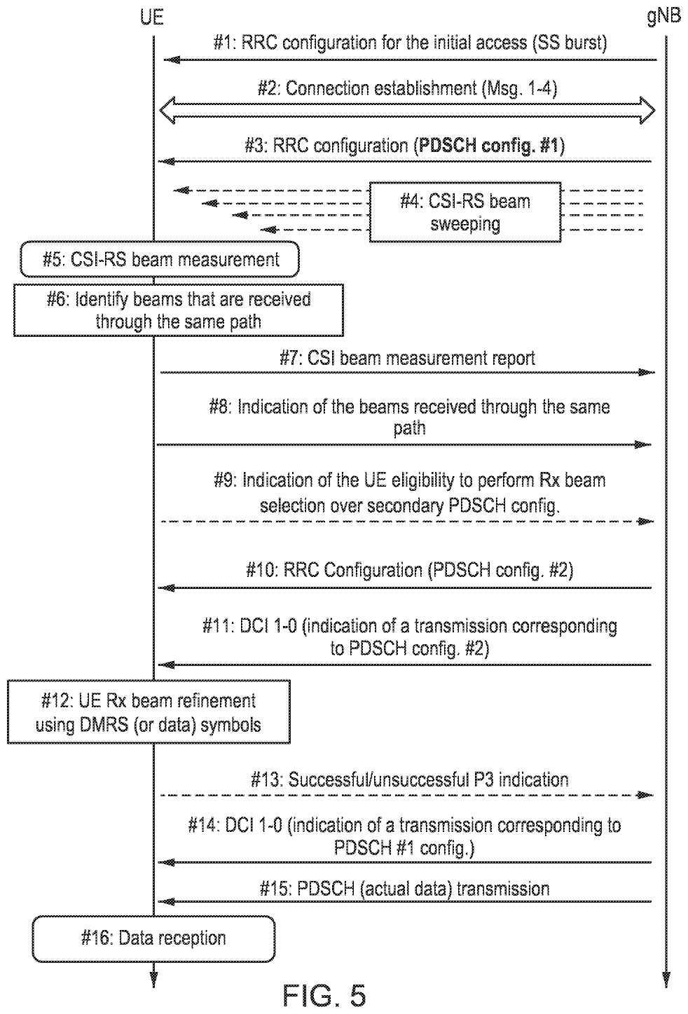

FIG. 5 illustrates a signaling flowchart example of certain embodiments. The approach of FIG. 5 can correspond to UE #1 configurations and operation in the scenario described in FIG. 3. UE #2 can follow UE #2's own configuration for data transmission.

Certain embodiments may enable the gNB to identify the opportunity to use a different beam than the serving one only for alignment purpose in a second UE, thus sharing and optimize the resources of the gNB. Concretely, for UE #1 the gNB may use a different beam than the serving one (for example, PDSCH of UE #2) as if the beam were a CSI-RS repetition to UE #1. The gNB can give the configuration of PDSCH of UE #2 to UE #1, for example time and frequency resources of the data and DMRS symbols. This provision of configuration can speed up alignment procedure for UE #1 and save network resources.

At #1 in FIG. 5, there can be RRC configuration. The gNB can periodically transmit a set of SS burst including parameters for initial access.

At #2 connection establishment, for example Msg.1-4 of a four-message random access procedure, can occur. The UE can measure SSBs, can select one with the highest received RSRP, and can trigger RA transmission. The gNB can transmit an RA response (RAR) that can carry (i) ID of successfully received preambles, (ii) Temporary Cell Radio Network Temporary Identifier (CRNTI), (iii) PUSCH uplink grants for Msg3, and the like. The UE can apply timing advance and can transmit Msg3 to the gNB using the PUSCH resources. Finally, the gNB can respond to Msg3 with the contention resolution message (Msg4) that contains the UE-ID which was successfully received in Msg3.

At #3 PDSCH Configuration #1 for actual data transmission to the UE can be provided to the UE. The gNB can configure the UE with the first set of PDSCH configuration used for actual data communication to the UE. The IE PDSCH-Config, and PDSCH-ConfigCommon, as described in 3GPP TS 38.331, can be used to identify UE-specific and cell-specific PDSCH configurations, respectively.

At #4 CSI-RS beam sweeping can be performed. The gNB can transmit a set of narrow CSI-RS beams within the angular span of the parent SSB beam.

At #5 CSI-RS beam measurement can occur. The UE can measure the RSRP of the CSI-RS beams, and can select N best ones (for example, N can be 4) to be configured as the serving beam (usually the one with the highest received RSRP or SINR) and for BFR.

At #6 the UE can identify beams that are received through a similar path. The UE can determine CSI beams that are received through a similar path as that of the serving beam. Here, the UE can check the quasi-co-location (QCL) relationship provided from network between the different CSI beams and the anchor SSB beam. If there is a QCL Type-D relationship, the UE can use this CSI beam for the UE's beam refinement. Additionally, the UE can check that aligning to the alternative CSI beams results in the same UE narrow beam. For example, the UE may have the same UE Rx spatial filtering, which may be done for example with angle of arrival (AoA) estimation or power delay profile (PDP). The similarity in receive path can be controlled at the UE and can depend on the half-power beamwidth of the serving panel, which can be UE implementation specific. For example, a typical 1×4 array can exhibit 22 degrees half-power beamwidth. Alternative CSI beams received within half-power beamwidth can result in choosing the same UE refined beam for alignment procedure as the one chosen for the serving CSI. Thus, an alternative CSI beam may not be seen on a side lobe of the UE pattern.

At #7 the UE can provide a CSI measurement report. For example, the UE can report the selected CSI-RS beam index and corresponding measured quantity, for example, reference signal received power (RSRP).

At #8, in addition to the CSI measurement report, the UE can provide an indication of the beams that are received from a similar path as that of the serving beam. The UE can provide the network with information of the additional CSI beams that are received from a similar path. For example, these may be additional CSI beams that are best received at the UE on the same UE narrow beam as that used for the serving CSI. The UE can align with the same Rx spatial filter for the additional beams as for the serving beam. The similar paths from different CSI beams can be received within the half-power beamwidth of the same UE narrow beam with good RSRP level, where a good RSRL level may be within, for example, 3 dB as that of serving beam. This information can be transmitted as a flag, as a new MAC-CE entry in the UL, as a new field in a CSI report, or as an enhancing group-based beam reporting functionality. The gNB can combine this information with QCL info of DL RS.

As an example, and for the proposed scenario in FIG. 3, UE #1 can indicate which of the gNB beams are received from the similar path as that of the UE's serving beam. Those gNB beams may need to be received by the similar UE Rx spatial filter (for example, the same receive beam) and it may be up to the UE to define the beamwidth of the chosen Rx narrow beam.

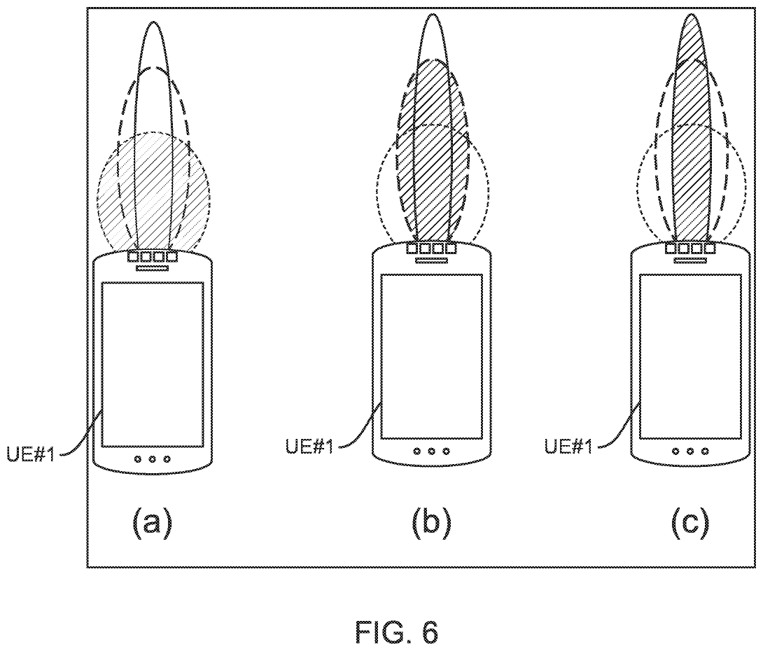

FIG. 6 provides three examples of user equipment reception spatial filter configurations with (a) 90-degree half-power beam width (HPBW), (b) 45 degree HPBW, and (c) 22 degree HPBW. Within each respective angle, paths can be considered coming from similar angle.

Referring again to FIG. 5, at #9 the gNB can provide an indication of the UE eligibility to perform Rx beam selection over secondary PDSCH configuration. This information can be dynamically transmitted depending on the RS as a new MAC-CE entry in the UL or as part of UE capability for dedicated functionality for all secondary RS.

At #10 RRC PDSCH Configuration #2 for the UE Rx beam tuning can be provided to the UE. The gNB can provide the UE with the second set of PDSCH configurations. This PDSCH configuration may not be intended for actual data transmission to the UE, but can include the DMRS information that can be used for UE Rx beam tuning only.

There may be various options for how such features may be implemented. According to a first option, this PDSCH configuration could originally belong to another user with semi-persistent scheduling (SPS) type of traffic, which can be shared by the gNB. In another option, the gNB could select and share a popular configuration that is commonly used for scheduling different UEs, without focusing on the actual usage of a particular UE.

At #11 the gNB can send an activation of the secondary resource, for example PDSCH #2 configuration, only for UE Rx beam alignment. When there is a PDSCH with same beam ID as that of the UE serving beam (or a beam received from the same path as the serving beam), the gNB can transmit an indication to inform the UE about the transmission. This indicator can have a structure similar to DCI 1-0 but with limited information entries including an identifier for DCI format, time/frequency of allocated resources, the applied MCS, and, for example, one additional bit informing the UE that the UE is not required to decode this PDSCH and can use it for P3.

In case PDSCH #2 originally belongs to a UE with SPS traffic (presented as Option 1 in #10), the indicator can be transmitted one time to inform the start of SPS. For dynamic scheduling (Option 2 in #10), a dynamic indicator transmission can inform the transmission time of such PDSCH.

The UE Rx beam alignment on config #2 could be done by performing energy measurement of data symbols, assuming interference is limited.

At #12 UE Rx beam tuning can be performed based on DMRS of config #2. Once the indicator has been received at #11, then based on the DMRS/data configurations, the UE can sweep the UE's receive beam and find a beam that maximizes the reception performance in terms of RSRP or SINR.

As a first option, the UE may sweep the UE's beam only over DMRS symbols. In this scenario, depending on the DMRS configuration and number of UE beams, the PDSCH may need to have a length of multiple consecutive slots.

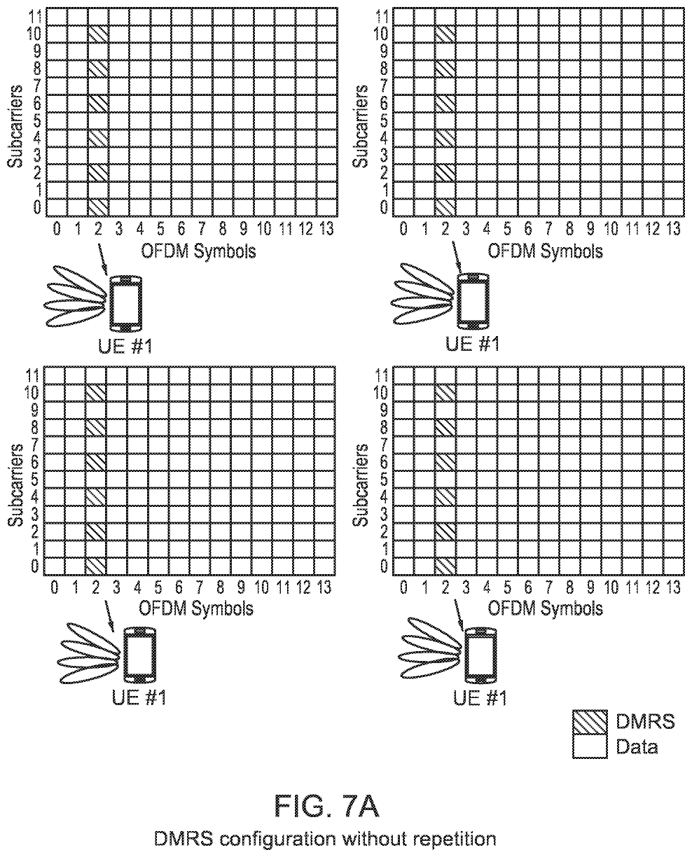

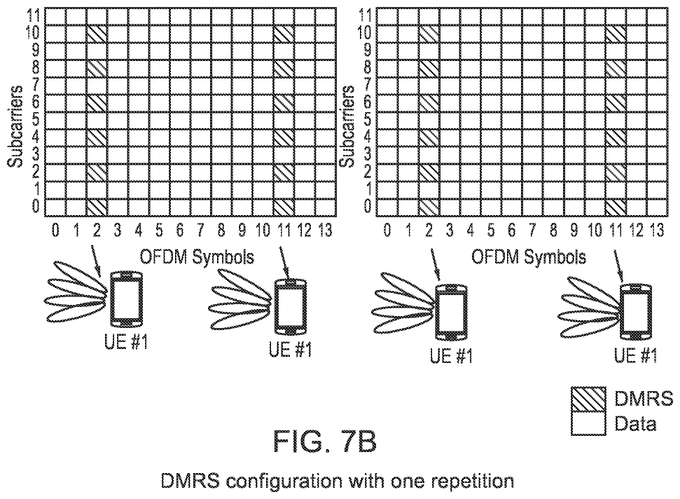

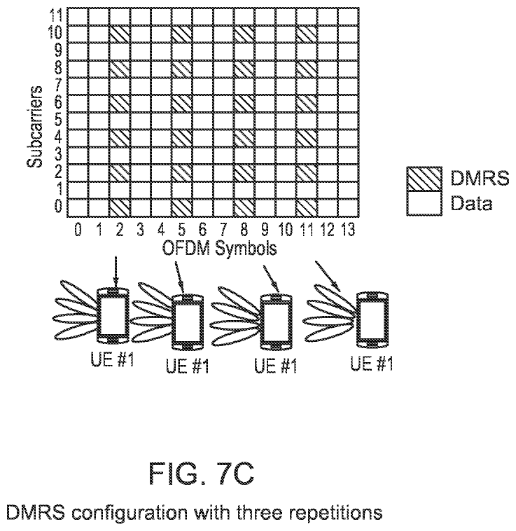

FIG. 7 illustrates a comparison of different repetition use cases with a four receive beam configuration, according to certain embodiments. As shown in FIG. 7, four Rx beams and DMRS configurations are shown with zero, one, and three repetitions, by way of example.

In FIG. 7, UE #1 Rx beam refinement over DMRS type-A of a secondary UE (for example, UE #2) based on the scenario described in FIG. 3. (A) illustrates DMRS configuration of secondary UE with no repetition. (B) illustrates DMRS configuration of secondary UE with one repetition. (C) illustrates DMRS configuration of secondary UE with three repetitions.

As an additional option, the UE can use the data symbols in addition to the DMRS symbols of the secondary UE to perform Rx beam alignment. For example, the UE can determine an interference level on DMRS symbol of config. #2 with receive broad beam, for example using a single active element in the antenna array. If the signal to interference plus noise ratio (SINR) of DMRS on UE broad beam is below a level, it may be too risky to use the data symbols, as the UE could end up aligning its narrow beam to interference instead of wanted signal. The level may be UE implementation specific, for example 6 dB or any other predetermined threshold.

If the SINR of DMRS on UE broad beam is above the level, the UE can use also the data symbols for UE Rx beam alignment. For example, in a limited interference scenario, the UE could perform beam sweeping over data symbols by measuring the received power of the data. Interference level can be obtained, as mentioned above, by decoding DMRS symbols with broad UE beam.

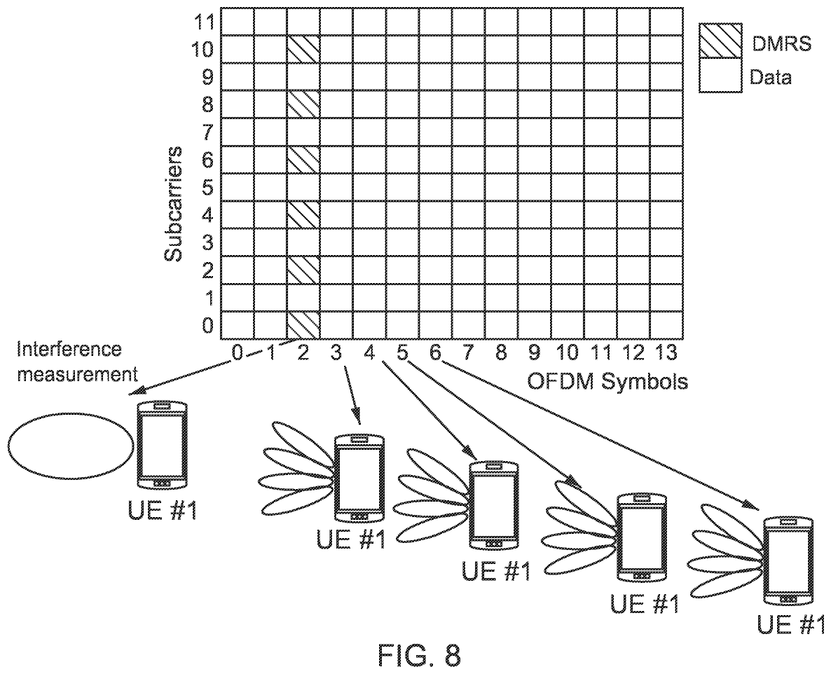

FIG. 8 presents one example of performing measurements based on data symbols, according to certain embodiments. In the illustrated scenario, the UE may be able to find the UE's best Rx beam faster and within one slot and may not require multiple consecutive slots of PDSCH allocation.

As shown in FIG. 8, UE #1Rx beam tuning can be performed using data symbols of a secondary UE (for example, UE #2) under the same gNB serving beam for the example described in FOG. 3. As shown from left to right, the UE can first evaluate interference with the DMRS symbols, which the UE may be able to decode, and if the interference level is appropriate, the UE can then measure energy of the data symbols that the UE is unable to decode.

Referring again to FIG. 5, at #13 there can be successful or unsuccessful P3 completion over config. #2. The UE could provide the gNB with a feedback on the accomplishment of P3 with DMRS and/or data of secondary UE. The UE can inform the gNB whether P3 was successful or whether the UE needs additional CSI-RS repetitions or the gNB can deactivate repetitions of config. #1. Deactivating repetitions for a UE can refer to discontinuing assigning the repetitions to the UE, or otherwise stopping assigning the repetitions to the UE.

At #14 and #15 actual data transmission can occur. The gNB can provide the UE with information of the actual data transmission.

At #16, there can be data reception, as the UE can receive the actual data through the tuned beam which was set in #12.

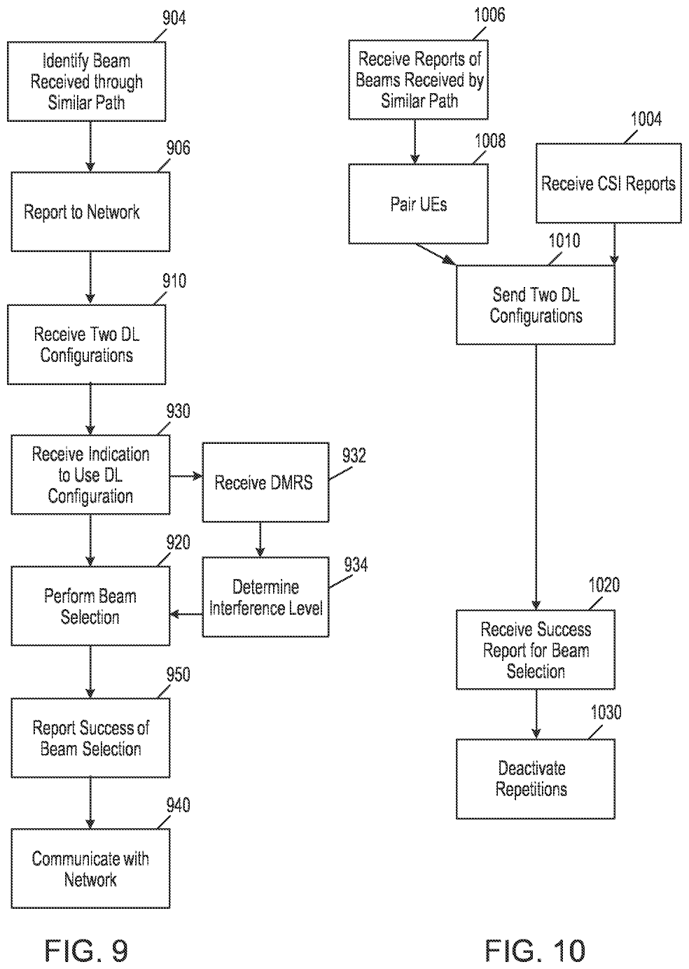

FIG. 9 illustrates an example flow diagram of a method for providing facilitation of beam refinement for a user equipment, according to certain embodiments. Certain embodiments are related to device reception (Rx) beam refinement, phase 3 (P3), where the UE needs reference signals from the network, for example from a serving next generation Node B (gNB) to align the UE's own Rx beam. Certain embodiments may avoid the need to consume a large number of channel state information reference signal (CSI-RS) resources for narrow beam alignment. The method can include, at 910, receiving, at user equipment, two sets of downlink configuration. A first set of the two sets can be configured to provide first downlink data to the user equipment. For example, first set of downlink configuration can enable the user equipment to receive first downlink data in the way that a PDCCH configuration enables reception of PDCCH. This first set of DL configuration can be for DL data slots for the user equipment, and may be used for data decoding not necessarily including beam management reference signals.

A second set of the two sets can be configured to provide second downlink data to another user equipment. For example, the second set of downlink configuration can enable the another user equipment to receive the second downlink data, without necessarily enabling the user equipment to receive second downlink data. The second set can be indicated as being for beam management for the user equipment. This second set of DL configuration can be a configuration of DL data slots for the other user equipment. Thus, the user equipment can receive DMRS for the other user equipment but cannot fully decode the data for the other user equipment. Still, the user equipment may be able to measure the energy per symbol of the data and use the energy measurements to align the user equipment's own narrow beam. The user equipment and the another user equipment can have a same reception beam or a similar reception beam. More particularly, the user equipment and the another user equipment can receive a same beam or receive a similar beam. In other words, the gNB beam that provides data to the user equipment and data to the another user equipment may be the same beam or a similar beam. This can be referred to as the transmission beam (or beams) from the standpoint of the gNB, as the beam (or beams) may be formed by the gNB.

Thus, in certain embodiments, a UE that is being served by the same (or even similar) beam as another UE, may also receive reference signals sent to the other UE for the alignment of the UE's own reception beam. For example, the UE can use the DMRS of the other UE, which is periodically sent anyway to the other UE. By using DMRS of the other UE, the need for CSI-RS configuration (for example, repetitions) can be avoided for the UE. Although the gNB may provide the first set of DL configuration to the user equipment for data reception for the user equipment, the gNB may choose or not to activate, with DCI, aperiodic scheduling of CSI-RS with repetition ‘on’ for UE narrow beam alignment. Thanks to configuration of the other user equipment sent to the user equipment, the user equipment can do beam alignment with DMRS of the other user equipment (which may be sent anyway) and the gNB may not need to schedule CSI-RS repetition for the user equipment.

The method can also include, at 920, performing a beam selection procedure using the second set. This may be P3 beam selection as discussed above. The beam selection can be performed based on at least one measurement of a signal transmitted using the second set.

The downlink configuration can include two physical downlink shared channel configurations, as described above.

The second set can be insufficient to permit full decoding of the second downlink data by the user equipment. The second set can be considered insufficient if the user equipment cannot fully decode the second downlink data using the second set of downlink configuration. In this case, downlink data can be distinguished from non-data information, such as a demodulation reference signal symbols. Thus, for example, the second set can be sufficient to permit processing a demodulation reference signal by the user equipment. The second set can be considered sufficient to permit processing a demodulation reference signal if the second set of downlink configuration enables the user equipment to decode the demodulation reference signal successfully. The signal sent according to the second set may be sufficient to be used as a received power to align a UE beam. Full decoding can be distinguished from partial decoding. For example, the second set may permit symbol level decoding or even bit level decoding, as long as the data intended for the other user equipment remains secure.

The downlink configuration can include parameters of a specific ongoing semi-persistent scheduling transmission on a serving beam.

The downlink configuration can include parameters of a shared configuration.

The method can further include, at 930, receiving an indication that the second set is usable with a particular downlink transmission. This indication may be provided, for example, in DCI, as mentioned above. A separate indication may also indicate when the first set is to be used. The performing the beam selection procedure comprises performing the beam selection using the particular downlink transmission.

The particular downlink transmission can include embedded demodulation reference signal symbols. Examples of such a transmission are discussed above, by way of example. The particular downlink transmission can also include data symbols. The performing the beam selection procedure can include measuring energy of the data symbols without fully decoding the data symbols. As mentioned above, some partial decoding of the data symbols, such as symbol level or bit level decoding of the data symbols may be done without fully decoding the data symbols.

The method can further include, at 940, performing data communication between the user equipment and a network using the first set.

The method can include, at 904, identifying at least one beam of a network element received through a similar path to a path receiving a serving beam of the network element. Similarity may be based on the geometry of the receive beams, as discussed above. The method can further include at 906, reporting the at least one beam to the network element. The reporting the at least one beam can include reporting that the user equipment is capable of performing beam refinement over at least one of demodulation reference symbols or data symbols. The reporting the at least one beam can include reporting that the beam is to be used for user equipment beam alignment rather than for switching.

The method can also include, at 932, receiving a demodulation reference signal using the second set. The method can further include, at 934, determining a level of interference to the demodulation reference signal. The performing the beam selection can be based on energy measurement of data symbols when the level of signal to interference exceeds a predetermined threshold. For example, as mentioned above, the predetermined threshold may be 6 dB.

The method can further include, at 950, reporting a success status of the beam selection procedure to the network after using the second set.

It is noted that FIG. 9 is provided as one example embodiment of a method or process. However, certain embodiments are not limited to this example, and further examples are possible as discussed elsewhere herein.

FIG. 10 illustrates an example flow diagram of a method for providing facilitation of beam refinement for a user equipment, according to certain embodiments. The method of FIG. 10 can be used alone or in combination with the method of FIG. 9.

The method can include, at 1010, sending two sets of downlink configuration to a user equipment. These can be the same two sets of downlink configuration received at 910 and discussed above.

The method can also include at, 1004, receiving channel state information reports from the user equipment and from the another user equipment. The sending the user equipment the two sets of downlink configuration at 1010 can be based on the received reports.

Moreover, at 1006, the method can include receiving reports of beams that are received through a similar path to a serving beam. The method can further include, at 1008, pairing the user equipment and the another user equipment. The sending the two sets of downlink configuration at 1010 can be based on the pairing based on the received reports.

The method can also include, at 1020, receiving a report of a success status of a beam selection procedure from the user equipment. This may be the same report sent at 950 in FIG. 9. The method of FIG. 10 can further include, at 1030, deactivating repetitions for the user equipment conditioned on the beam selection procedure being reported successful. As mentioned above, further repetitions for P3 beam selection may not be necessary if the user equipment can take advantage of data transmissions to another user equipment.

It is noted that FIG. 10 is provided as one example embodiment of a method or process. However, certain embodiments are not limited to this example, and further examples are possible as discussed elsewhere herein.

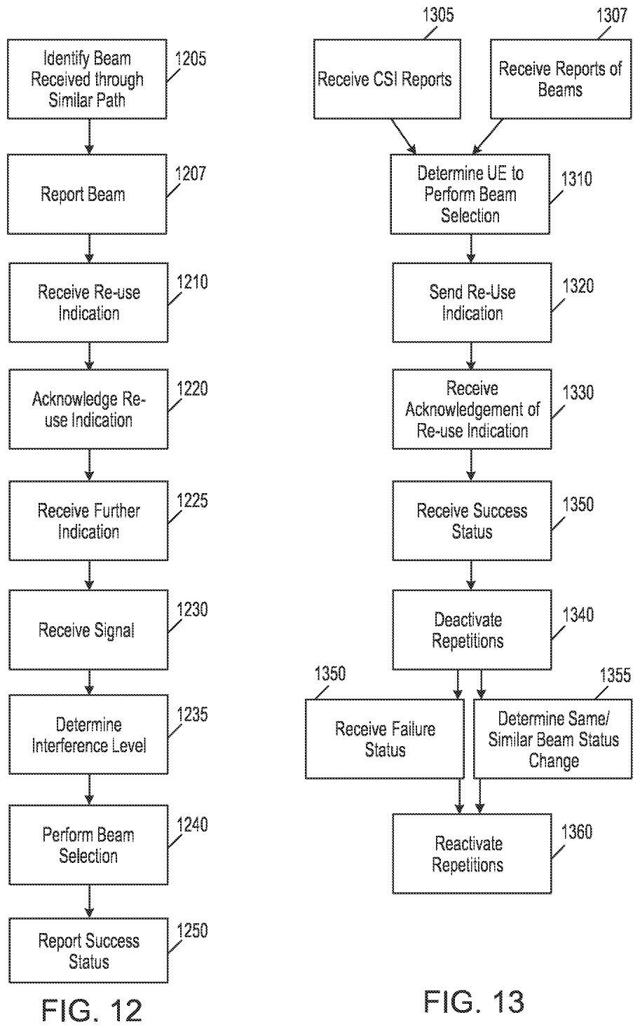

FIG. 12 illustrates an example flow diagram of a method for providing facilitation of beam refinement for a user equipment, according to certain embodiments. FIG. 12 may be viewed as another embodiment similar in various aspects to the method shown in FIG. 9.

As shown in FIG. 12, a method can include, at 1210, receiving, at a user equipment, an indication from a network element to use a downlink configuration to perform a beam selection procedure by using a signal transmitted to another user equipment. The user equipment and the another user equipment can be served by a same beam or by similar beams. See the discussion above regarding how beams can be similar to one another. This indication can be referred to, for convenience, as a re-use indication, since the signal (for example, a DMRS) can be re-used for beam forming by one user equipment, even while it is used for usual DMRS purposes by another user equipment.

The method of FIG. 12 can also include, at 1220, acknowledging, by the user equipment, reception of the indication. The method can further include, at 1230, receiving, by the user equipment, the signal transmitted to the another user equipment. This may be the DMRS that is to be used as a DRMS by the another user equipment.

The method can further include, at 1240, performing the beam selection procedure based on the signal, wherein the beam selection procedure is performed based on at least one measurement of the signal.

As in the example of FIG. 9, the downlink configuration can be a physical downlink shared channel configuration. The downlink configuration may be insufficient to permit the user equipment to fully decode data encoded by the signal, but may be sufficient to permit the user equipment to process a demodulation reference signal of the another user equipment. More particularly, the downlink configuration may include parameters of a specific ongoing semi-persistent scheduling transmission on a serving beam. The downlink configuration may include parameters of a shared configuration, as described above.

The method can also include, at 1225, receiving, at the user equipment, a further indication that the downlink configuration is usable with a particular downlink transmission. The further indication can be included in downlink control information (DCI). In some cases, the further indication may be the only indication. For example, the further indication may both indicate that the downlink configuration is usable with a particular downlink transmission and that a previously configured downlink configuration is to be used. This approach may be particularly beneficial when a sufficiently shared downlink configuration is used, such that the user equipment can at least identify the time and frequency resources of the particular downlink transmission and measure the energy of one or more symbols thereof. The receiving the signal at 1230 can include receiving the particular downlink transmission, such as the particular instance of DRMS. The performing the beam selection procedure at 1240 can include performing the beam selection procedure using the particular downlink transmission.

The particular downlink transmission can be embedded demodulation reference signal symbols. The particular downlink transmission can include data symbols. The performing the beam selection procedure at 1240 can include measuring energy of the data symbols without fully decoding the data symbols.

The method can also include, at 1205, identifying, by the user equipment, at least one beam of a network element received through a similar path to a path receiving a serving beam of the network element. The method can further include, at 1207, reporting, by the user equipment, the at least one beam to the network element. The reporting the at least one beam can include reporting that the user equipment is capable of performing the beam selection procedure over at least one of demodulation reference symbols or data symbols. The reporting the at least one beam can include reporting the at least one beam for user equipment beam selection rather than for switching.

The receiving at 1230 can include receiving, at the user equipment, a demodulation reference signal using the downlink configuration. The method can further include, at 1235, determining, by the user equipment, a level of interference to the demodulation reference signal. The performing the beam selection procedure at 1240 can be based on energy measurement of data symbols when the level of signal to interference exceeds a predetermined threshold.

The method can also include, at 1250, reporting, by the user equipment, a success status of the beam selection procedure to the network after using the downlink configuration.

In certain embodiments, a UE can inform the gNB that a condition that was the basis of reuse does not hold. In this option, the UE can just provide information to the gNB for the gNB to decide whether to discontinue the indicated re-use. This may be derived by the gNB from routine reports without a special UE indication in the case of the same beam approach mentioned above.

For a similar beams approach, the UE may provide information since UE may report up to four best beam L1-RSRP and no extra indications. There is a case where gNB could not detect that condition does not hold if the similar beam is not part of the routine reported beams. In this case, the UE can provide an indication that the condition does not hold. If the UE is not providing routine reports on the similar gNB beam, the UE may check that the similar beam is best received with the same UE narrow beam as the serving gNB beam. This condition may not hold with dynamic multipath environment and sudden blockage, upon which UE can indicate the change to the network.

It is noted that FIG. 12 is provided as one example embodiment of a method or process. However, certain embodiments are not limited to this example, and further examples are possible as discussed elsewhere herein.

FIG. 13 illustrates an example flow diagram of a method for providing facilitation of beam refinement for a user equipment, according to certain embodiments. The method of FIG. 13 can be used alone or in combination with the method of FIG. 12. The method of FIG. 13 may be viewed as another implementation of a method such as that discussed above with reference to FIG. 10.

The method of FIG. 13 may include, at 1310, determining, by a network element, a user equipment to perform a beam selection procedure by using a signal transmitted to another user equipment. The user equipment and the another user equipment can be served by a same beam or can be served by similar beams.

There are various ways that the gNB can decide which UE should be scheduled with repetitions and which UE should not be scheduled with repetitions. For example, according to a first option, the gNB can use a first come/first served approach. Under this approach, if a UE is newly to be configured with dedicated CSI-RS repetitions, the gNB can check whether another UE is served with the same/similar beam and has existing dedicated CSI-RS repetitions that can be reused for the new UE. If so, the new UE gets an indication to reuse the existing dedicated CSI-RS repetitions.

According to a second option, a random or arbitrary approach can be applied. Under this approach, if any two or more UEs are served with a same/similar beam, the gNB can arbitrarily or randomly assign the reuse role to one of the UEs and can provide an indication to the other UE, or the rest of the UEs if there are more than two total, to operate using the existing dedicated CSI-RS repetitions.

According to a third option, a last come first served approach can be used. This can be the same as the first approach, except in this case the new UE can get the dedicated CSI-RS repetitions and the existing UE can get the indication to perform reuse.

According to a fourth option, any other desired selection mechanism can be applied. The gNB could use any other selection criterion. For example, a stationary UE or UE with low mobility could be favored over a high mobility UE to receive the dedicated CSI-RS repetitions, or vice versa. In short, any desired algorithm for deciding which UE reuses the other UE's can be adopted.

As a fifth option, both or multiple UEs can use each other's DMRS for alignment and none of them may be scheduled with repetitions.

The method may also include, at 1320, sending, by the network element, an indication to the user equipment to use a downlink configuration to perform the beam selection procedure. The downlink configuration can be used by the user equipment to perform the beam selection procedure by using the signal transmitted to the another user equipment.

The method may further include, at 1330, receiving, at the network element, an acknowledgment of reception of the indication to use the downlink configuration. Optionally, the network element may assume that the indication was received unless a negative acknowledgment is sent within a predetermined window or before the expiration of a timer.

The method may additionally include, at 1340, deactivating, by the network element, repetitions to be used by the user equipment for the purpose of performing the beam selection procedure.

The method may include, at 1305, receiving, at the network element, channel state information reports from the user equipment and from the another user equipment. The determining the user equipment at 1310 can be based on the channel state information reports.

The method may also include, at 1307, receiving, at the network element, reports of beams that are received through a similar path to a serving beam. The determining at 1310 can be based on the reports.

The method can further include, at 1335, receiving, at the network element, a report of a success status of a beam selection procedure from the user equipment. The deactivating the repetitions for the user equipment, at 1340, can be conditioned on the beam selection procedure being reported successful.

The method can also include, at 1350, receiving, at the network element, a report of a failure status of a beam selection procedure from the user equipment. The method can further include, at 1360, reactivating, by the network element, the repetitions for the user equipment conditioned on the beam selection procedure being reported failed.

The method can further include, at 1355, determining, by the network element, that the user equipment and the another user equipment no longer receive the same beam nor receive the similar beams. The reactivating, at 1360, the repetitions can be conditioned on the determination at 1355 that the user equipment and the another user equipment no longer receive the same beam nor receive the similar beams.

It is noted that FIG. 13 is provided as one example embodiment of a method or process. However, certain embodiments are not limited to this example, and further examples are possible as discussed elsewhere herein.

Note that with a dynamic environment, UE beam selection can be a continuous process for the UE and may be influenced by multi-path, mobility, and UE rotation, rather than being a one time selection. The UE may switch from using CSI-RS dedicated to the UE to DMRS of another UE for the UE's own narrow beam selection according to gNB indication, for example the gNB's activation/configuration.

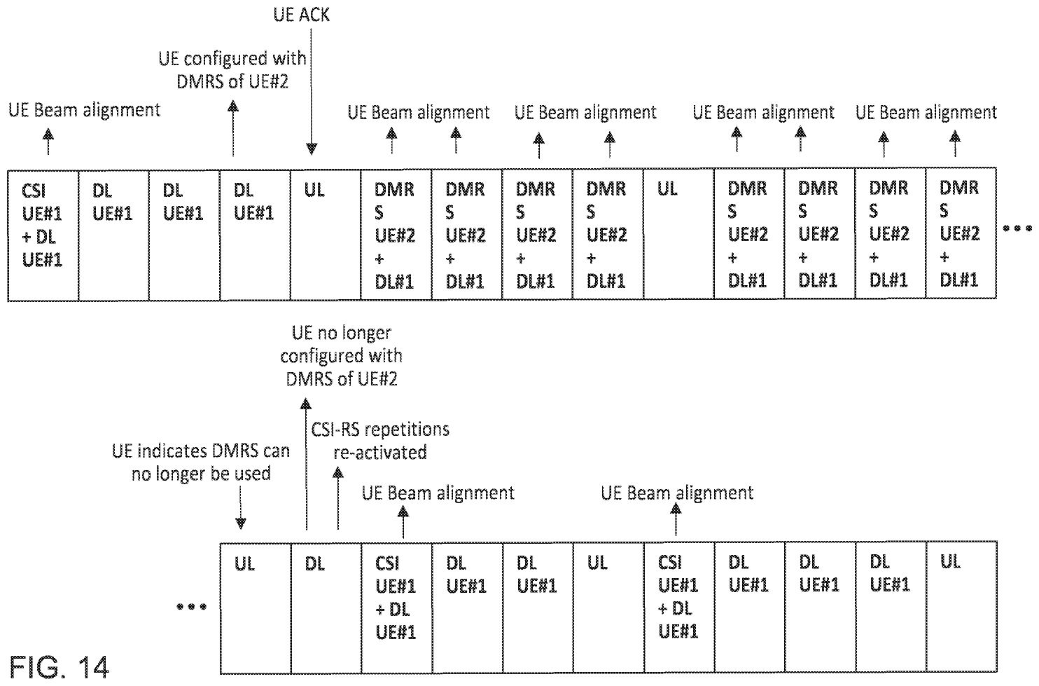

FIG. 14 illustrates a dynamic process of beam selection, according to certain embodiments. As shown in FIG. 14, proceeding from left to right, initially a first UE, UE #1, can be receiving CSI and DL. The UE can perform UE beam alignment initially. After some periods of DL, the UE can be configured by the gNB with a configuration to receive the DMRS of another UE, UE #2. In UL, the UE #1 can acknowledge the configuration. UE #1 can then perform UE beam alignment using the DMRS of UE #2 for a period of time. At some point, the UE #1 can indicate, explicitly or implicitly, that the DMRS can no longer be used. Accordingly, the gNB can discontinue configuration of UE #2's DMRS to UE #1 for beam alignment, and can reactivate CSI-RS repetitions for UE #1. Thus, UE #1 can perform subsequent beam alignment using the CSI repetitions. This is just an example timeline, as the dynamic conditions of the radio environment of any given UE may vary.

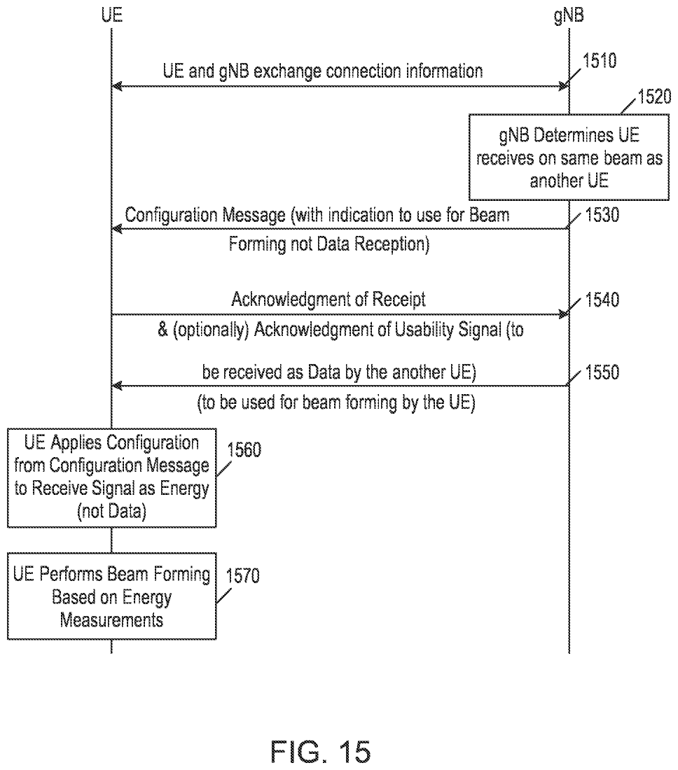

FIG. 15 illustrates a signal flow chart according to certain embodiments. As shown in FIG. 15, at 1510, the UE and gNB can exchange connection information. At 1520, the gNB can determine that a given UE receives on a same beam as another UE, or that the two UEs receive on similar beams.

At 1530, the gNB can send a configuration message to the UE. This configuration message may include an indication to use the configuration for beamforming, rather than using the configuration for data reception. Optionally, the indication could indicate that the configuration can be used both for beamforming and also for data reception.

At 1540, the UE can acknowledge receipt of the configuration message. Optionally, the UE can also acknowledge that the configuration is usable for beamforming. For example, the UE can indicate that the UE has the capability to perform beamforming using the provided configuration or more generally that the UE has the capability to perform beamforming by re-using a signal to another UE.

At 1550, the gNB can send the signal to the another UE. The UE can, at 1560, apply the configuration from the configuration message to receive the signal as energy, rather than as data. Optionally, part or all of the signal can be received as data. At 1570, the UE can perform beamforming based on energy based on energy measurements.

In this example, performing beamforming can refer to selecting a best beam from a plurality of possible beams. Such approaches can also be referred to in other ways, such as beam refinement or the like.

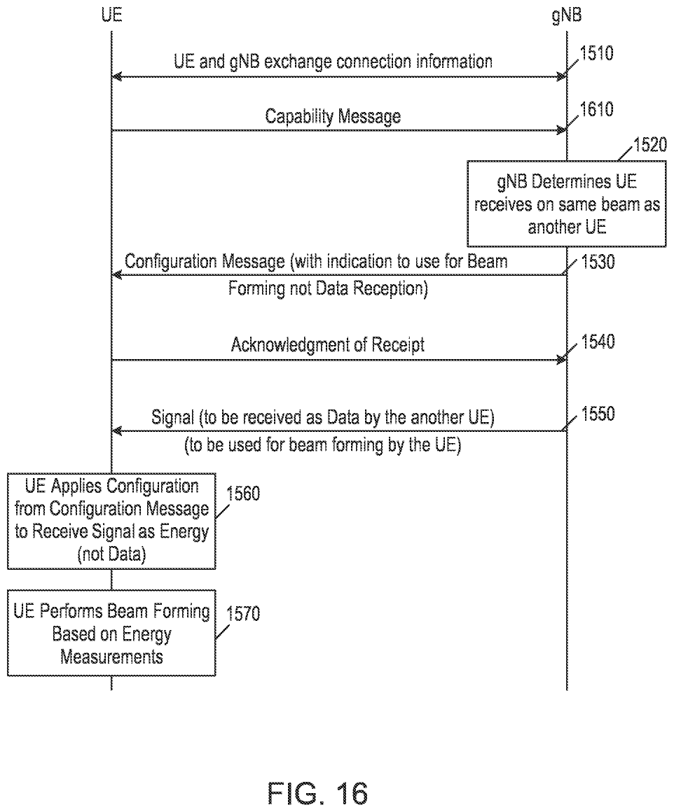

FIG. 16 illustrates a further signal flow chart according to certain embodiments. The embodiment illustrated in FIG. 16 may be similar to that shown in FIG. 15, except that in FIG. 16, the acknowledgment of usability at 1540 in FIG. 15 can be replaced by the capability message at 1610 in FIG. 16. In this approach, the gNB may be able to avoid considering the UE at 1520 and configuring the UE with a beamforming configuration at 1530, unless the UE first indicates explicitly or implicitly that the UE is capable of performing such beamforming based on re-use of a signal to another UE.

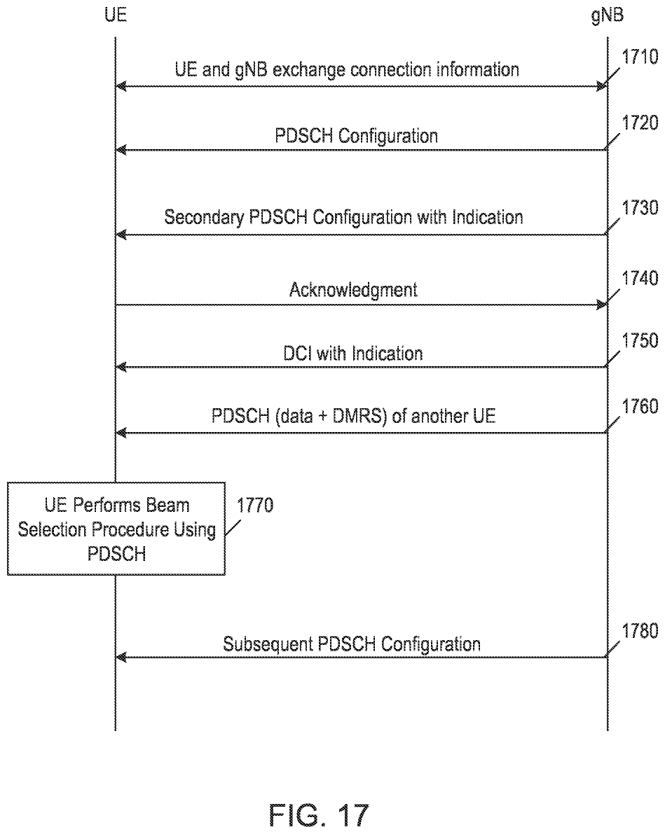

FIG. 17 illustrates yet another signal flow chart according to certain embodiments. The flow chart of FIG. 17 may correspond to the same approach illustrated in FIG. 15, but illustrates additional messages and some more specific examples of particular messages.

As shown in FIG. 17, at 1710, the UE and gNB can exchange connection information. At 1720, the gNB can provide a first PDSCH configuration to the UE. The first PDSCH configuration for the UE may for the UE to use for receiving data on the PDSCH. Subsequently, the gNB may provide a secondary PDSCH configuration with an indication that this secondary configuration is to be used for beamforming, rather than to receive data for the UE. The UE can, at 1740, can be provide an acknowledgment, which can be an acknowledgment of receipt of the secondary configuration and/or an indication that the UE is capable of performing re-use of the secondary PDSCH configuration for beam forming. In certain embodiments, the secondary PDSCH configuration message at 1730 (or any of the other messages sent by the gNB) may be sent as a negative acknowledgment message. In such a case, the gNB may set a timer or start a window and may assume that the message has been received and successfully decoded, unless a negative acknowledgment is received before the expiration of the timer or the end of the window.

At 1750, the gNB can send a DCI with an indication. This indication in DCI can identify for the UE the location, for example the time-frequency resource(s), of the forthcoming PDSCH of another UE. At 1760, the gNB can send the PDSCH to the another UE, which can also be received by the UE. The PDSCH can include data plus a DMRS. The UE may not be able to decode the data of the PDSCH, but may evaluate the energy of, for example, the bits of the DMRS, to perform a beam selection procedure at 1770. The beam selection procedure can refer to the same thing as the beam forming. Subsequently, at 1780, the gNB may send a subsequent PDSCH configuration, which may be a message like that at 1720 or 1730. The gNB may distinguish between a primary PDSCH configuration for the UE to receive data intended for the UE and a secondary PDSCH configuration for the UE to use for beam selection, by providing an indication with the PDSCH configuration or in a separate message.

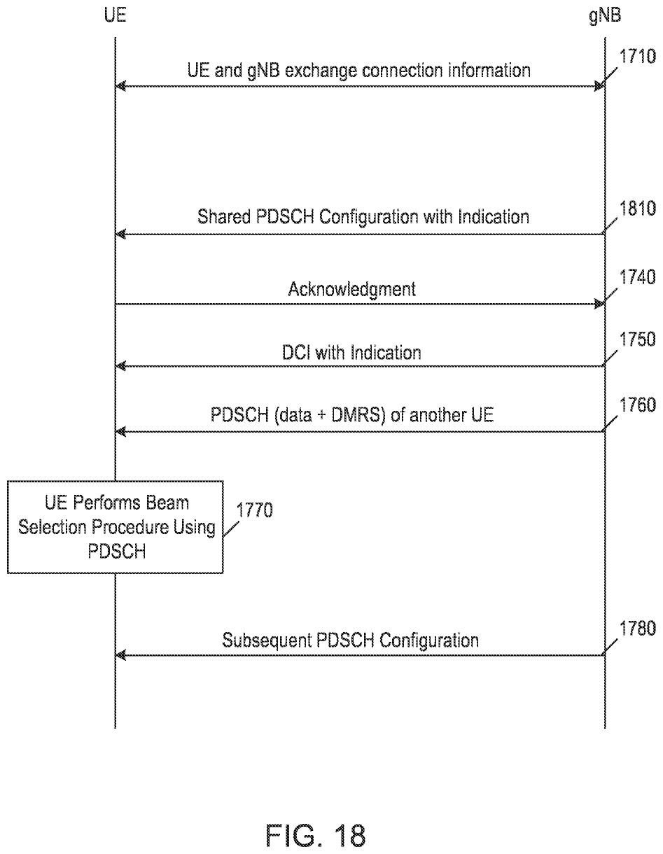

FIG. 18 illustrates an additional signal flow chart according to certain embodiments. The approach of FIG. 18 may be the same as that of FIG. 17, except that the two PDSCH configurations can be replaced by a single shared PDSCH configuration. At 1810, the shared PDSCH configuration can be provided to the UE together with an indication that the shared PDSCH configuration is for the UE's own data reception, but also for the UE to perform beam forming/beam selection.

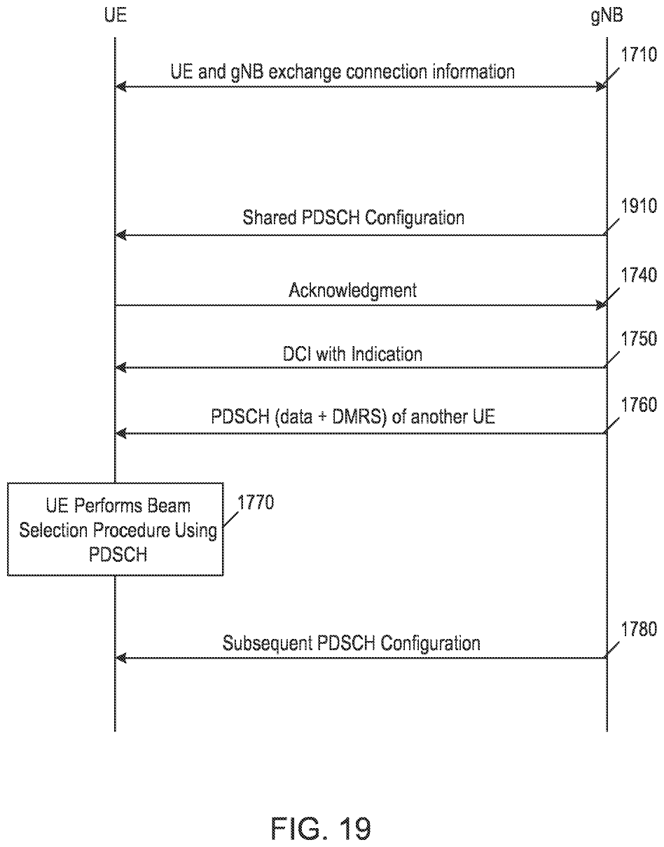

FIG. 19 illustrates another signal flow chart according to certain embodiments. The approach of FIG. 19 may be the same as that of FIG. 18, except that, at 1910, the shared PDSCH configuration can be provided to the UE without an indication that the shared PDSCH configuration is for the UE's own data reception, but also for the UE to perform beam forming/beam selection. Instead, such an indication may provided for the first time with the DCI at 1750.

The above-described and illustrated examples provide various options that can be used individually or together with one another. Other variations on the above approaches are also permitted.

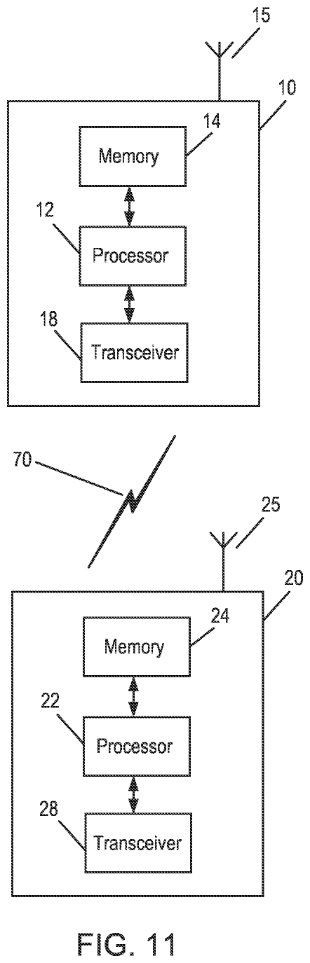

FIG. 11 illustrates an example of a system that includes an apparatus 10 according to an embodiment. In an embodiment, apparatus 10 may be a node, host, or server in a communications network or serving such a network. For example, apparatus 10 may be a network node, satellite, base station, a Node B, an evolved Node B (eNB), 5G Node B or access point, next generation Node B (NG-NB or gNB), TRP, HAPS, integrated access and backhaul (IAB) node, and/or a WLAN access point, associated with a radio access network, such as a LTE network, 5G or NR. In some example embodiments, apparatus 10 may be gNB or other similar radio node, for instance.

It should be understood that, in some example embodiments, apparatus 10 may comprise an edge cloud server as a distributed computing system where the server and the radio node may be stand-alone apparatuses communicating with each other via a radio path or via a wired connection, or they may be located in a same entity communicating via a wired connection. For instance, in certain example embodiments where apparatus 10 represents a gNB, it may be configured in a central unit (CU) and distributed unit (DU) architecture that divides the gNB functionality. In such an architecture, the CU may be a logical node that includes gNB functions such as transfer of user data, mobility control, radio access network sharing, positioning, and/or session management, etc. The CU may control the operation of DU(s) over a front-haul interface. The DU may be a logical node that includes a subset of the gNB functions, depending on the functional split option. It should be noted that one of ordinary skill in the art would understand that apparatus 10 may include components or features not shown in FIG. 11.

As illustrated in the example of FIG. 11, apparatus 10 may include a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, or any other processing means, as examples. While a single processor 12 is shown in FIG. 11, multiple processors may be utilized according to other embodiments. For example, it should be understood that, in certain embodiments, apparatus 10 may include two or more processors that may form a multiprocessor system (e.g., in this case processor 12 may represent a multiprocessor) that may support multiprocessing. In certain embodiments, the multiprocessor system may be tightly coupled or loosely coupled (e.g., to form a computer cluster).

Processor 12 may perform functions associated with the operation of apparatus 10, which may include, for example, precoding of antenna gain/phase parameters, encoding and decoding of individual bits forming a communication message, formatting of information, and overall control of the apparatus 10, including processes related to management of communication or communication resources.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media, or other appropriate storing means. The instructions stored in memory 14 may include program instructions or computer program code that, when executed by processor 12, enable the apparatus 10 to perform tasks as described herein.

In an embodiment, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10.

In some embodiments, apparatus 10 may also include or be coupled to one or more antennas 15 for transmitting and receiving signals and/or data to and from apparatus 10. Apparatus 10 may further include or be coupled to a transceiver 18 configured to transmit and receive information. The transceiver 18 may include, for example, a plurality of radio interfaces that may be coupled to the antenna(s) 15, or may include any other appropriate transceiving means. The radio interfaces may correspond to a plurality of radio access technologies including one or more of global system for mobile communications (GSM), narrow band Internet of Things (NB-IoT), LTE, 5G, WLAN, Bluetooth (BT), Bluetooth Low Energy (BT-LE), near-field communication (NFC), radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (via an uplink, for example).

As such, transceiver 18 may be configured to modulate information on to a carrier waveform for transmission by the antenna(s) 15 and demodulate information received via the antenna(s) 15 for further processing by other elements of apparatus 10. In other embodiments, transceiver 18 may be capable of transmitting and receiving signals or data directly. Additionally or alternatively, in some embodiments, apparatus 10 may include an input and/or output device (I/O device), or an input/output means.

In an embodiment, memory 14 may store software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

According to some embodiments, processor 12 and memory 14 may be included in or may form a part of processing circuitry/means or control circuitry/means. In addition, in some embodiments, transceiver 18 may be included in or may form a part of transceiver circuitry/means.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

As introduced above, in certain embodiments, apparatus 10 may be or may be a part of a network element or RAN node, such as a base station, access point, Node B, eNB, gNB, TRP, HAPS, IAB node, relay node, WLAN access point, satellite, or the like. In one example embodiment, apparatus 10 may be a gNB or other radio node, or may be a CU and/or DU of a gNB. According to certain embodiments, apparatus 10 may be controlled by memory 14 and processor 12 to perform the functions associated with any of the embodiments described herein. For example, in some embodiments, apparatus 10 may be configured to perform one or more of the processes depicted in any of the flow charts or signaling diagrams described herein, such as those illustrated in FIGS. 1-10 and 12-19, or any other method described herein. In some embodiments, as discussed herein, apparatus 10 may be configured to perform a procedure relating to providing facilitation of beam refinement for a user equipment, for example.

FIG. 11 also illustrates an example of an apparatus 20 according to another embodiment. Thus, the system of FIG. 11 can include both apparatus and apparatus 20. In an embodiment, apparatus 20 may be a node or element in a communications network or associated with such a network, such as a UE, communication node, mobile equipment (ME), mobile station, mobile device, stationary device, IoT device, or other device. As described herein, a UE may alternatively be referred to as, for example, a mobile station, mobile equipment, mobile unit, mobile device, user device, subscriber station, wireless terminal, tablet, smart phone, IoT device, sensor or NB-IoT device, a watch or other wearable, a head-mounted display (HMD), a vehicle, a drone, a medical device and applications thereof (e.g., remote surgery), an industrial device and applications thereof (e.g., a robot and/or other wireless devices operating in an industrial and/or an automated processing chain context), a consumer electronics device, a device operating on commercial and/or industrial wireless networks, or the like. As one example, apparatus 20 may be implemented in, for instance, a wireless handheld device, a wireless plug-in accessory, or the like.

In some example embodiments, apparatus 20 may include one or more processors, one or more computer-readable storage medium (for example, memory, storage, or the like), one or more radio access components (for example, a modem, a transceiver, or the like), and/or a user interface. In some embodiments, apparatus 20 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 20 may include components or features not shown in FIG. 11.

As illustrated in the example of FIG. 11, apparatus 20 may include or be coupled to a processor 22 for processing information and executing instructions or operations. Processor 22 may be any type of general or specific purpose processor. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 11, multiple processors may be utilized according to other embodiments. For example, it should be understood that, in certain embodiments, apparatus 20 may include two or more processors that may form a multiprocessor system (e.g., in this case processor 22 may represent a multiprocessor) that may support multiprocessing. In certain embodiments, the multiprocessor system may be tightly coupled or loosely coupled (e.g., to form a computer cluster).

Processor 22 may perform functions associated with the operation of apparatus 20 including, as some examples, precoding of antenna gain/phase parameters, encoding and decoding of individual bits forming a communication message, formatting of information, and overall control of the apparatus 20, including processes related to management of communication resources.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In an embodiment, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20.

In some embodiments, apparatus 20 may also include or be coupled to one or more antennas 25 for receiving a downlink signal and for transmitting via an uplink from apparatus 20. Apparatus 20 may further include a transceiver 28 configured to transmit and receive information. The transceiver 28 may also include a radio interface (e.g., a modem) coupled to the antenna 25. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 28 may be configured to modulate information on to a carrier waveform for transmission by the antenna(s) 25 and demodulate information received via the antenna(s) 25 for further processing by other elements of apparatus 20. In other embodiments, transceiver 28 may be capable of transmitting and receiving signals or data directly. Additionally or alternatively, in some embodiments, apparatus 20 may include an input and/or output device (I/O device). In certain embodiments, apparatus 20 may further include a user interface, such as a graphical user interface or touchscreen.

In an embodiment, memory 24 stores software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software.

According to an example embodiment, apparatus 20 may optionally be configured to communicate with apparatus 10 via a wireless or wired communications link 70 according to any radio access technology, such as NR.

According to some embodiments, processor 22 and memory 24 may be included in or may form a part of processing circuitry or control circuitry. In addition, in some embodiments, transceiver 28 may be included in or may form a part of transceiving circuitry.

As discussed above, according to some embodiments, apparatus 20 may be a UE, SL UE, relay UE, mobile device, mobile station, ME, IoT device and/or NB-IoT device, or the like, for example. According to certain embodiments, apparatus 20 may be controlled by memory 24 and processor 22 to perform the functions associated with any of the embodiments described herein, such as one or more of the operations illustrated in, or described with respect to, FIGS. 1-10 and 12-19, or any other method described herein. For example, in an embodiment, apparatus 20 may be controlled to perform a process relating to providing facilitation of beam refinement for a user equipment, as described in detail elsewhere herein.

In some embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of any of the operations discussed herein.

In view of the foregoing, certain example embodiments provide several technological improvements, enhancements, and/or advantages over existing technological processes and constitute an improvement at least to the technological field of wireless network control and/or management. Certain embodiments may have various benefits and/or advantages. For example, certain embodiments may reduce the number of CSI-RS repetitions required for Rx beam selection at the user end. Moreover, the UE may be able to more frequently and faster re-select the UE's receive beam, hence improving performance.

In some example embodiments, the functionality of any of the methods, processes, signaling diagrams, algorithms or flow charts described herein may be implemented by software and/or computer program code or portions of code stored in memory or other computer readable or tangible media, and may be executed by a processor.

In some example embodiments, an apparatus may include or be associated with at least one software application, module, unit or entity configured as arithmetic operation(s), or as a program or portions of programs (including an added or updated software routine), which may be executed by at least one operation processor or controller. Programs, also called program products or computer programs, including software routines, applets and macros, may be stored in any apparatus-readable data storage medium and may include program instructions to perform particular tasks. A computer program product may include one or more computer-executable components which, when the program is run, are configured to carry out some example embodiments. The one or more computer-executable components may be at least one software code or portions of code. Modifications and configurations required for implementing the functionality of an example embodiment may be performed as routine(s), which may be implemented as added or updated software routine(s). In one example, software routine(s) may be downloaded into the apparatus.

As an example, software or computer program code or portions of code may be in source code form, object code form, or in some intermediate form, and may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and/or software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality of example embodiments may be performed by hardware or circuitry included in an apparatus, for example through the use of an application specific integrated circuit (ASIC), a programmable gate array (PGA), a field programmable gate array (FPGA), or any other combination of hardware and software. In yet another example embodiment, the functionality of example embodiments may be implemented as a signal, such as a non-tangible means, that can be carried by an electromagnetic signal downloaded from the Internet or other network.

According to an example embodiment, an apparatus, such as a node, device, or a corresponding component, may be configured as circuitry, a computer or a microprocessor, such as single-chip computer element, or as a chipset, which may include at least a memory for providing storage capacity used for arithmetic operation(s) and/or an operation processor for executing the arithmetic operation(s).

Example embodiments described herein may apply to both singular and plural implementations, regardless of whether singular or plural language is used in connection with describing certain embodiments. For example, an embodiment that describes operations of a single network node may also apply to example embodiments that include multiple instances of the network node, and vice versa.

One having ordinary skill in the art will readily understand that the example embodiments as discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of example embodiments.

### PARTIAL GLOSSARY

AoA Angle of Arrival
BFR Beam Failure Recovery
CSI-RS Channel State Information Reference Signal
DL Downlink
DMRS Demodulation Reference Signal
gNB Next Generation Node-B
HPBW Half-Power Beam Width
NR 5G New Radio
OFDM Orthogonal Frequency Division Multiplexing
PBCH Physical Broadcast Channel
PDCCH Physical Downlink Control Channel
PDCP Packet Data Convergence Protocol
PDSCH Physical Downlink Shared Channel
PUCCH Physical Uplink Control Channel
RA Random Access
RACH Random Access Channel
RO Random Access Occasion
RRC Radio Resource Control
RSRP Reference Signal Received Power
SIB System Information Block
SR Smart Repeater
SRS Sounding Reference Signal
SSB Synchronization Signal Block
SSBRI SSB Resource Block Indicators
SSS Secondary Synchronization Signal
TDD Time Division Duplexing
UE User Equipment
UL Uplink

1. An apparatus, comprising:
at least one processor; and
at least one memory including computer program instructions,
wherein the at least one memory and the computer program instructions are configured to, with the at least one processor, cause the apparatus at least to:
receive a downlink configuration for a beam selection procedure;
receive an indication to use a signal in the beam selection procedure, wherein the signal is targeted at a user equipment other than the apparatus, wherein the apparatus and the user equipment are served by a same beam or by similar beams;
receive the signal, wherein the signal is transmitted on a beam corresponding to the same beam or one of the similar beams; and
perform the beam selection procedure based on measurements of the signal.

2. The apparatus of claim 1, wherein the indication is received with the downlink configuration or wherein the indication is received after the downlink configuration.

3. The apparatus of claim 1, wherein the at least one memory and the computer program instructions are configured to, with the at least one processor, further cause the apparatus at least to:
send an acknowledgment that the apparatus is capable of using the signal to perform the beam selection procedure.

4. The apparatus of claim 1, wherein the downlink configuration comprises at least one of:
a physical downlink shared channel configuration;
parameters of a specific ongoing semi-persistent scheduling transmission on a serving beam; or
parameters of a shared configuration.

5. The apparatus of claim 1, wherein the downlink configuration is sufficient to permit the apparatus to process a demodulation reference signal of the user equipment other than the apparatus, wherein the signal comprises the demodulation reference signal.

6. The apparatus of claim 1, wherein the at least one memory and the computer program instructions are further configured to, with the at least one processor, further cause the apparatus at least to:
receive a further indication that the downlink configuration is usable with a particular downlink transmission,
wherein the receiving the signal comprises receiving the particular downlink transmission, and
wherein the performing the beam selection procedure comprises performing the beam selection procedure using the particular downlink transmission.

7. The apparatus of claim 6, wherein the particular downlink transmission comprises embedded demodulation reference signal symbols; or
wherein the particular downlink transmission comprises data symbols and the performing the beam selection procedure comprises measuring energy of the data symbols without fully decoding the data symbols.

8. The apparatus of claim 6, wherein the further indication is received in downlink control information.

9. The apparatus of claim 1, wherein the at least one memory and the computer program instructions are further configured to, with the at least one processor, further cause the apparatus at least to:
receive the signal comprising a demodulation reference signal; and
determine a level of interference to the demodulation reference signal,
wherein the performing the beam selection procedure is based on energy measurement of data symbols when the level of signal to interference exceeds a predetermined threshold.

10. The apparatus of claim 1, wherein the at least one memory and the computer program instructions are further configured to, with the at least one processor, further cause the apparatus at least to:
report a success status of the beam selection procedure to the network after using the signal.

11. An apparatus, comprising:
at least one processor; and
at least one memory including computer program instructions,
wherein the at least one memory and the computer program instructions are configured to, with the at least one processor, cause the apparatus at least to:
determine a user equipment to perform a beam selection procedure, wherein the beam selection procedure is to be performed using a signal targeted at another user equipment, wherein the user equipment and the another user equipment are served by a same beam or by similar beams;
send a downlink configuration for the beam selection procedure to the user equipment;
send an indication to the user equipment to use the signal to perform the beam selection procedure; and
send the signal using a beam corresponds to the same beam or one of the similar beams.

12. The apparatus of claim 11, wherein the indication is sent with the downlink configuration or wherein the indication is sent after the downlink configuration.

13. The apparatus of claim 11, wherein the at least one memory and the computer program instructions are configured to, with the at least one processor, further cause the apparatus at least to:
receive an acknowledgment that the user equipment is capable of using the signal to perform the beam selection procedure.

14. The apparatus of claim 11, wherein the at least one memory and the computer program instructions are configured to, with the at least one processor, further cause the apparatus at least to:
receive channel state information reports from the user equipment and from the another user equipment, wherein the determining the user equipment is to perform the beam selection procedure is based on the channel state information reports.

15. The apparatus of claim 11, wherein the at least one memory and the computer program instructions are configured to, with the at least one processor, further cause the apparatus at least to:
receive reports of beams that are received through a similar path to a serving beam, wherein the determining that the user equipment is to perform the beam selection procedure is based on the reports.

16. The apparatus of claim 11, wherein the at least one memory and the computer program instructions are configured to, with the at least one processor, further cause the apparatus at least to:
deactivate repetitions to be used by the user equipment for the purpose of performing the beam selection procedure.

17. The apparatus of claim 16, wherein the at least one memory and the computer program instructions are configured to, with the at least one processor, further cause the apparatus at least to:
receive a report of a success status of a beam selection procedure from the user equipment, wherein the deactivating the repetitions for the user equipment is conditioned on the beam selection procedure being reported successful.

18. The apparatus of claim 16, wherein the at least one memory and the computer program instructions are configured to, with the at least one processor, further cause the apparatus at least to:
receive a report of a failure status of a beam selection procedure from the user equipment; and reactivate the repetitions for the user equipment conditioned on the beam selection procedure being reported failed.

19. The apparatus of claim 16, wherein the at least one memory and the computer program instructions are configured to, with the at least one processor, further cause the apparatus at least to:
determine that the user equipment and the another user equipment no longer receive the same beam nor receive the similar beams; and
reactivate the repetitions for the user equipment conditioned on the determination that the user equipment and the another user equipment no longer receive the same beam nor receive the similar beams.

20. A method, comprising:
receiving, at a user equipment, a downlink configuration for a beam selection procedure;
receiving, at the user equipment, an indication to use a signal in the beam selection procedure, wherein the signal is targeted at another user equipment, wherein the user equipment and the another user equipment are served by a same beam or by similar beams;
receiving the signal by the user equipment, wherein the signal is transmitted on a beam corresponding to the same beam or one of the similar beams; and
performing, by the user equipment, the beam selection procedure based on measurements of the signal.

21-33. (canceled)
